(19) United States
(12) Patent Application Publication
(10) Pub. No.: US 2024/0425283 A1
(43) Pub. Date: Dec. 26, 2024

(54) INSTRUCTION DEVICE, HANDLING SYSTEM, HANDLING METHOD, PROGRAM, AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Akihito OGAWA, Fujisawa (JP); Kazuma HIRAGURI, Yokohama (JP); Yosuke YABE, Kawasaki (JP); Atsushi MATSUMURA, Yokohama (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/828,008

(22) Filed: Sep. 9, 2024

Related U.S. Application Data
(63) Continuation of application No. PCT/JP2023/011270, filed on Mar. 22, 2023.

(30) Foreign Application Priority Data
Mar. 23, 2022 (JP) 2022-046875

(51) Int. Cl. B65G 1/137; B65G 1/04

(52) U.S. Cl. CPC B65G 1/1378; B65G 1/0485

(57) ABSTRACT

According to one embodiment, an instruction device causes, in shipping processing, a plurality of transport devices transporting articles to move respectively to a first area and a second area. The first area and the second area faces each other with a work area interposed. A worker is in the work area. The instruction device further causes one of the plurality of transport devices to transfer the article with the worker in a first section adjacent to the first area. The instruction device further causes another one of the plurality of transport devices to transfer the article with the worker via a take-out device in a second section adjacent to the second area. The take-out device removes the article from the other one of the plurality of transport devices.

### CROSS-REFERENCE TO RELATED APPLICATIONS

This is a continuation application of International Patent Application PCT/JP2023/011270, filed on Mar. 22, 2023. This application also claims priority to Japanese Patent Application No. 2022-046875, filed on Mar. 23, 2022. The entire contents of which are incorporated herein by reference.

### FIELD

Embodiments of the invention relate to an instruction device, a handling system, a handling method, a program, and a storage medium.

### BACKGROUND

In a warehouse of articles, a worker receives or ships articles. A handling system that passes outgoing articles to the worker and receives incoming articles from the worker is used. Multiple transport devices are used in the handling system. The transport devices transport the articles according to commands from an instruction device.

### BRIEF DESCRIPTION OF THE DRAWINGS

FIG. 1 is a schematic view showing an example of a layout of a warehouse;

FIG. 2 is a schematic view showing a layout of a work area periphery of a handling system according to an embodiment;

FIGS. 3A and 3B are perspective views illustrating a specific example of a transport device;

FIGS. 4A to 4D are perspective views showing specific examples of shelves;

FIGS. 5A and 5B are perspective views illustrating a specific example of a take-out device;

FIG. 6 is a schematic view showing another example of a layout of a warehouse;

FIG. 7 is a schematic view showing the layout of the work area periphery;

FIG. 8 is a schematic view showing the layout of a robot work area periphery;

FIG. 9 is a perspective view showing a specific example of a picking robot;

FIG. 10 is a schematic view showing controls according to the handling system according to the embodiment;

FIG. 11 is a flowchart showing receiving processing according to the handling system according to the embodiment;

FIG. 12 is a flowchart showing select processing of a storage location according to the handling system according to the embodiment;

FIG. 13 is a flowchart showing shipping processing according to the handling system according to the embodiment;

FIG. 14 is a schematic view showing a layout of a work area periphery of a handling system according to a reference example;

FIG. 15 is a timing chart related to the handling system according to the embodiment;

FIG. 16 is another timing chart related to the handling system according to the embodiment;

FIG. 17 is a timing chart related to a handling system according to a reference example;

FIG. 18 is a schematic view showing another layout of the work area periphery of the handling system according to the embodiment;

FIG. 19 is a schematic view showing a layout of a robot work area periphery of the handling system according to the embodiment;

FIGS. 20A and 20B are schematic views showing layouts of robot work area peripheries of handling systems according to reference examples; and

FIG. 21 is a schematic view illustrating a hardware configuration.

### DETAILED DESCRIPTION

According to one embodiment, an instruction device causes, in shipping processing, a plurality of transport devices transporting articles to move respectively to a first area and a second area. The first area and the second area faces each other with a work area interposed. A worker is in the work area. The instruction device further causes one of the plurality of transport devices to transfer the article with the worker in a first section adjacent to the first area. The instruction device further causes another one of the plurality of transport devices to transfer the article with the worker via a take-out device in a second section adjacent to the second area. The take-out device removes the article from the other one of the plurality of transport devices.

Hereinafter, embodiments of the invention will be described with reference to the drawings.

The drawings are schematic or conceptual, and the relationship between the thickness and width of each portion, the proportions of sizes among portions, and the like are not necessarily the same as the actual values. Even the dimensions and proportion of the same portion may be illustrated differently depending on the drawing.

In the specification and drawings, components similar to those already described are marked with like reference numerals, and a detailed description is omitted as appropriate.

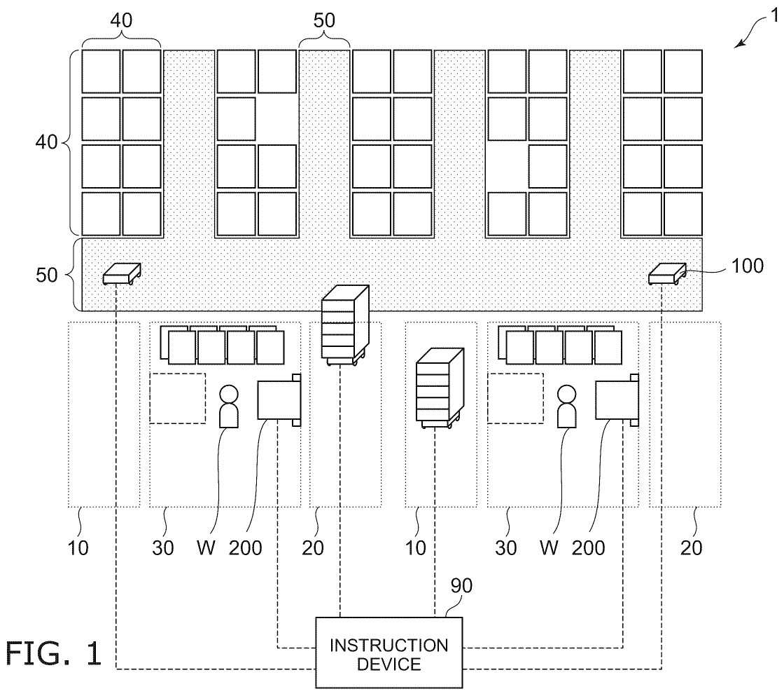

FIG. 1 is a schematic view showing an example of a layout of a warehouse.

For example, a handling system 1 according to an embodiment is applied to the warehouse shown in FIG. 1. The handling system 1 includes a transport device 100 and an auxiliary device. A first area 10, a second area 20, a work area 30, a storage area 40, and a travel area 50 are set in the warehouse.

Multiple shelves are located in the storage area 40. Multiple containers that can store articles are placed in each rack. Only one type of article may be stored in one container, or multiple types of articles may be stored in one container.

The transport device 100 transports articles. Specifically, the transport device 100 transports articles out of the storage area 40. Or, the transport device 100 transports articles into the storage area 40. The transport device 100 transports the articles by transporting one or multiple containers. The transport device 100 may transport multiple containers by transporting a rack.

The travel area 50 is set between the storage area 40 and the first area 10, between the storage area 40 and the second area 20, and between the storage area 40 and the work area 30. The transport device 100 moves through the travel area 50 and moves the article to the first area 10 or the second area 20.

A worker W works in the work area 30. The first area 10 and the second area 20 are set respectively at two sides of the work area 30. The multiple transport devices 100 move from the storage area 40 respectively to the first and second areas 10 and 20. The worker transfers the articles with the transport devices 100 that have moved to the first area 10 or the second area 20.

Herein, the act of moving an article, such as the operation of transporting the article out of the storage area 40 and passing the article to the worker, the operation of receiving the article from the worker and transporting the article into the storage area 40, etc., are called “handling”.

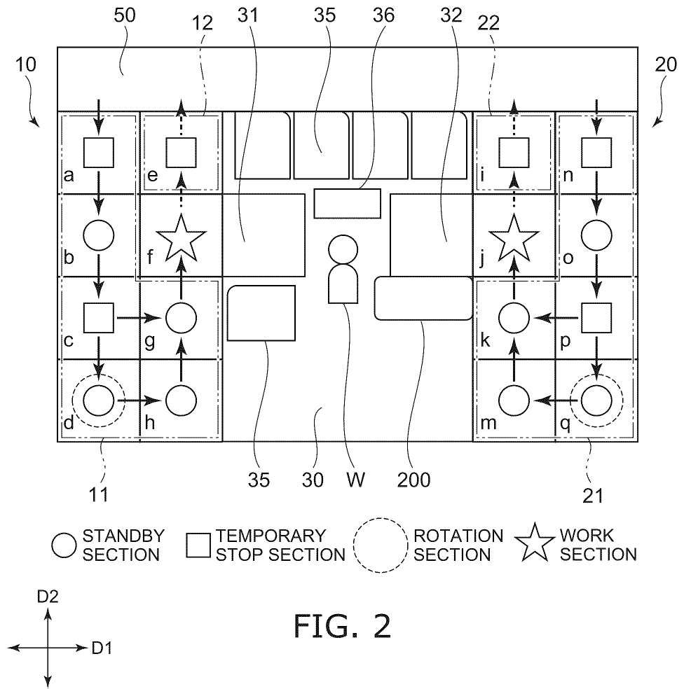

FIG. 2 is a schematic view showing a layout of the work area periphery of the handling system according to the embodiment.

For example, the worker W performs shipping tasks of the articles in the work area 30. In the work area 30, a first section 31 is set to a position adjacent to the first area 10. A second section 32 is set to a position adjacent to the second area 20. The worker W transfers the article with the transport device 100 stopped at a work section in the first section 31 or the second section 32.

An auxiliary device is installed at the second section 32. The auxiliary device is provided to assist the transfer of the articles between the worker and the rack transported by the transport device 100. In the illustrated example, a take-out device 200 is installed as the auxiliary device. The take-out device 200 removes a container from a rack transported by the transport device 100. Also, the take-out device 200 raises or lowers the container. For example, the take-out device 200 receives the container from the transport device 100 and lowers the container so that the worker can get the article inside the container. Also, after the work by the worker, the take-out device 200 raises the container and returns the container to the prescribed location of the transport device 100.

At the second section 32, the worker transfers the article with the transport device 100 via the take-out device 200. At the first section 31, the worker directly transfers the article with the transport device 100 without using the take-out device 200.

As shown in FIG. 1, the transport device 100 and the take-out device 200 can communicate with an instruction device 90. The instruction device 90 transmits instructions to the transport device 100 and the take-out device 200. The transport device 100 and the take-out device 200 operate according to the received instructions.

Advantages of the embodiment will now be described.

To effectively utilize the storage area 40, it is desirable to be able to store more articles in the storage area 40. To increase the number of articles that can be stored, it is effective to provide shelves at high positions in the storage area 40. For example, more articles can be stored in the shelves by using high shelves 25 or by adding shelves on the existing shelves.

When the transport device 100 transports such shelves, there is a possibility that the necessary articles may be at a position beyond the reach of the worker. The take-out device 200 is necessary to remove articles stored at high positions. On the 30 other hand, when transferring articles with the transport device 100 via the take-out device 200, the time necessary to transfer the articles increases by the time of the removal by the take-out device 200. The handling is delayed, and the efficiency of the handling decreases.

For this problem, in the handling system 1 according to the embodiment, the first area 10 and the second area 20 are set respectively at locations facing each other with the work area interposed; and the worker is in the work area. The transport device 100 moves to the first area 10 or the second area 20 according to the article that is transported. Then, at the first section 31 adjacent to the first area 10, the transport device 100 transfers the article with the worker. At the second section 32 adjacent to the second area 20, the transport device 100 transfers the article with the worker via the take-out device 200. For example, articles of high handling frequency are stored at positions (first positions) within reach of the worker when storing the articles in the shelves. Articles of low handling frequency are stored at high positions beyond the reach of the worker.

When the article to be passed to the worker is at a height within reach of the worker, the transport device 100 moves to the first area 10. The worker receives the article or the container from the transport device 100 with their own hands at the first section 31. When the article to be passed to the worker is at a height beyond the reach of the worker, the transport device 100 moves to the second area 20. The take-out device 200 receives the container from the transport device 100 at the second section 32. The worker receives the article inside the container from the take-out device 200.

At the second section 32, even articles of high positions can be transferred because the take-out device 200 is used. Therefore, the articles can be stored at high positions of the storage area 40; and the storage area 40 can be utilized more effectively. At the first section 31, the articles can be transferred without using the take-out device 200, and so a delay of the handling can be suppressed. For example, the worker can transfer articles with the transport device 100 at the first section 31 while the take-out device 200 is removing an article. According to the embodiment, articles at high positions of the transport device 100 can be transferred to and from the worker while suppressing an efficiency reduction of the handling.

The handling system 1 according to the embodiment will now be described in more detail.

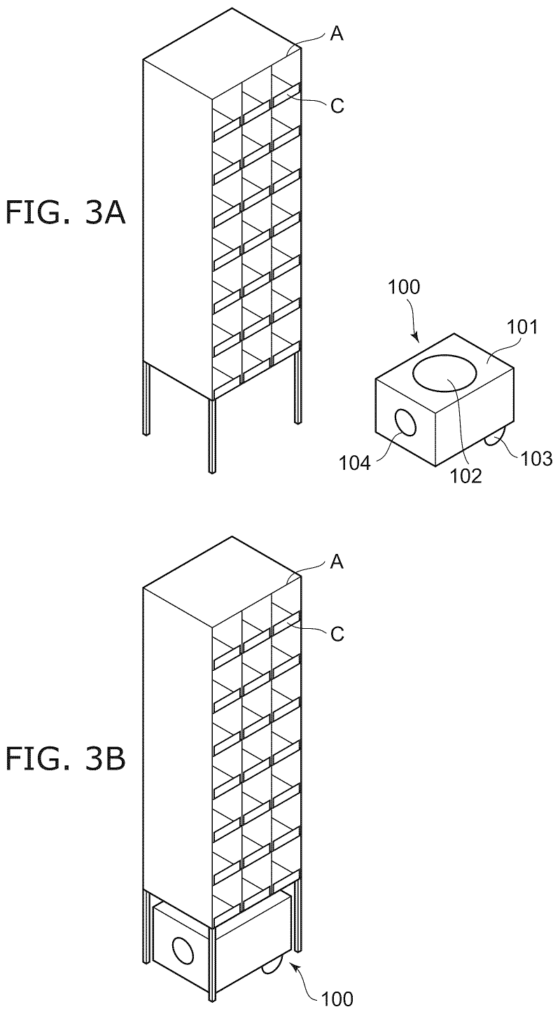

FIGS. 3A and 3B are perspective views illustrating a specific example of the transport device.

As shown in FIG. 3A, the transport device 100 can move a rack A storing multiple containers C by placing the rack A on the upper part of the transport device 100. The transport device 100 includes a vehicle body 101, a holding part 102, a running part 103, and a detecting part 104.

The holding part 102 is located at the upper part of the vehicle body 101. The holding part 102 is movable vertically with respect to the vehicle body 101. The running part 103 includes a motor, wheels, etc., and causes the vehicle body 101 to travel. The detecting part 104 detects the rack, container, etc., of the transport object. The detecting part 104 includes a sensor such as a camera, etc. The detecting part 104 may include a distance sensor, etc.

When transporting the rack A, the transport device 100 moves under the rack A as shown in FIG. 3B. The holding part 102 is raised, and supports the rack A from below. In this state, the rack A can be transported by operating the running part 103.

The transport device 100 is an automated guided vehicle (AGV) that travels along guides installed in the floor. Or, the transport device 100 is an autonomous mobile robot (AMR) that uses sensors of the detecting part 104 to autonomously travel to match the conditions of the surroundings. The transport device 100 may travel along a travel route set by an instruction device or other computer.

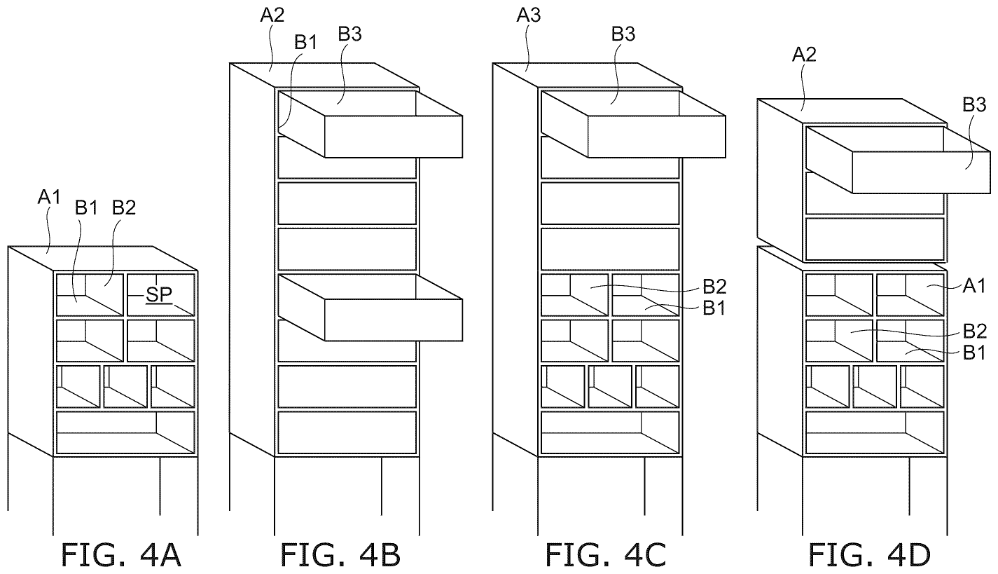

FIGS. 4A to 4D are perspective views showing specific examples of shelves.

For example, as shown in FIG. 4A, a rack A1 that includes horizontal dividers B1 and vertical dividers B2 is used. Spaces SP that are sectioned by the dividers B1 and B2 are used as containers. Or, as shown in FIG. 4B, a rack A2 that includes extractable boxes B3 may be used. The box B3 is located on the divider B1 and used as a container. The box B3 is removed from the rack A2 and returned to the rack A2 by the take-out device 200. The sizes of the containers located in one rack may be the same or may be different from each other.

As shown in FIG. 4C, a rack A3 that includes the structure of the rack A1 and the structure of the rack A2 may be used. The dividers B1 and B2 are located at the lower part of the rack A3. The boxes B3 are located at the upper part of the rack A3. As shown in FIG. 4D, the rack A2 may be added on the rack A1. By adding the rack A2 on an existing rack A1 in the storage area 40, the number of articles that can be stored in the shelves can be increased, and the utilization efficiency of the storage area 40 can be increased. The transport device 100 can simultaneously transport the rack A1 and the additional rack A2. Generally, the rack A1 that uses spaces as containers is more inexpensive than the rack A2 that includes the extractable boxes B3. By using the rack A1 or A3, the necessary cost can be reduced compared to when the rack A2 is applied to all of the shelves located in the storage area 40.

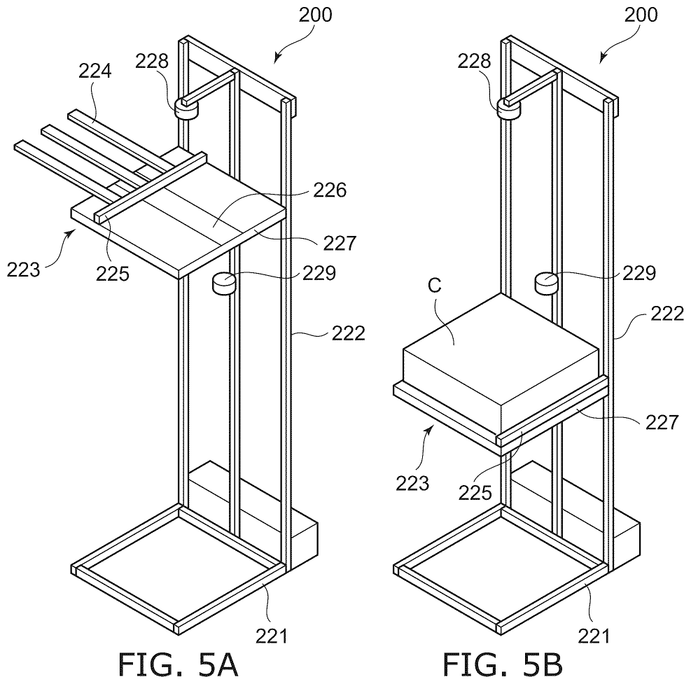

FIGS. 5A and 5B are perspective views illustrating a specific example of a take-out device.

The take-out device 200 shown in FIGS. 5A and 5B includes a base 221, a drive mechanism 222, and a holding part 223. The base 221 is mounted to the floor surface and stores drive components such as electrical parts, a motor, etc. The drive mechanism 222 is located on the base 221 and drives the holding part 223 along the vertical direction.

The holding part 223 includes a support mechanism 224, a suction-grasping part 225, a drive mechanism 226, and a loading platform 227. The support mechanism 224 has a fork shape extending along the longitudinal direction. The support mechanism 224 and the suction-grasping part 225 are configured as one piece, and can be moved in the longitudinal direction over the loading platform 227. The “longitudinal direction” is the direction connecting the take-out device 200 and the rack when the rack transported by the transport device 100 is positioned adjacent to the take-out device 200. The drive mechanism 226 drives the support mechanism 224 and the suction-grasping part 225 along the longitudinal direction. A container that stores articles can be loaded onto the loading platform 227.

When the rack transported by the transport device 100 approaches, the take-out device 200 operates the drive mechanism 226 and moves the support mechanism 224 and the suction-grasping part 225 toward the rack as shown in FIG. 5A. The support mechanism 224 is inserted between the rack and the container. The support mechanism 224 supports the container from below. The suction-grasping part 225 grasps the side surface of the container. The container is held by the support mechanism 224 and the suction-grasping part 225.

By the drive mechanism 226 removing the container in the state in which the container is held, the container C moves onto the loading platform 227 as shown in FIG. 5B. Also, by the drive mechanism 222 lowering the loading platform 227, the articles can be moved to a position at which the picking task is easy. After completing the picking task, the drive mechanism 222 returns the holding part 223 to the original height. The drive mechanism 226 drives the holding part 223 toward the rack. By releasing the grasping of the suction-grasping part 225, the container C is returned to the rack. After the drive mechanism 226 retracts the support mechanism 224 and the suction-grasping part 225, the transport device 100 moves in the exit direction. Other than suction-grasping, the holding part 223 may include a mechanism that clamps the side surface of the container. The holding part 223 may hold the container C by hooking the container C with a hook-shaped tab mechanism, etc.

The take-out device 200 may further include a sensor 228 for imaging the interior of the container, and a sensor 229 for acquiring information of the article removed from the container. An RGB image camera, a range image camera, or the like that images the interior of the container is used as the sensor 228 for the container. Information such as the number of articles stored in the container, the placement state, the types of articles, etc., can be acquired from the imaging result. The sensor 229 for measuring the held article is a sensor for acquiring the number, shape, or information of articles removed from the container. A camera, line sensor, laser rangefinder (LRF), light detection and ranging (LIDAR), barcode reader, or the like is used as the sensor 229.

Instead of the take-out device 200, a staircase may be provided as the auxiliary device. In such a case, the worker can ascend the staircase, remove an article from a high position of the rack, and place an article at a high position of the rack.

As shown in FIG. 2, entry lines 11 and 21 into which the transport device 100 enters are set respectively in the first and second areas 10 and 20. Also, an exit line 12 and an exit line 22 from which the transport device 100 exits are set respectively in the first and second areas 10 and 20. The entry line 11 is a region before the work section in the first area 10. The exit line 12 is a region after the work section in the first area 10. The transport device 100 moves to the work section of the first area 10 by passing through the entry line 11, and exits from the first area 10 by passing through the exit line 12. The entry line 21 is a region before the work section in the second area 20. The exit line 22 is a region after the work section in the second area 20. The transport device 100 moves to the work section of the second area 20 by passing through the entry line 21, and exits from the first area 10 by passing through the exit line 22.

Here, the task of removing a specific article from a container and transferring the article to another container or box is called “picking”. One or more shipping boxes 35 and a processing terminal 36 are located in the work area 30. The worker W checks the article to be picked based on information displayed in the processing terminal 36. The worker W receives the container storing the article to be picked from the transport device 100 in one of the first area 10 or the second area 20. After transferring the article stored in the container to the shipping box 35, the worker W returns the container to the transport device 100. The worker inputs a report of the work progress to the processing terminal 36 as appropriate.

Multiple shipping boxes are prepared in the work area 30. Therefore, the worker W can store articles from one container in multiple shipping boxes 35 having different delivery destinations, and can efficiently perform the picking task. Also, by setting multiple sections at which transferring with the transport device 100 can be performed, the worker can transfer a container with one section and then immediately transfer a container at another section. As a result, the efficiency of the handling can be increased.

The first area 10 and the second area 20 include multiple sections defined to have a prescribed size. The operations that the transport device 100 can perform in each section are predetermined. The size of the section is arbitrary. Considering the utilization efficiency of the warehouse, it is favorable for the size of the section to be a value in which a margin is added to the size of the rack or container to be transported. The margin is set based on an error such as fluctuation when moving the transport device 100, etc.

In the illustrated example, the entry line 11 includes the sections a, b, c, d, h, and g; and the exit line 12 includes the section e. The entry line 21 includes the sections n, o, p, q, m, and k; and the exit line 22 includes the section i. A direction that connects the first area 10 and the second area 20 is called a first direction D1. The sections a to d, the sections e to h, the sections i to m, and the sections n to q are set along a second direction D2 crossing the first direction D1. The sections e to h are positioned between the work area 30 and the sections a to d. The sections i to m are positioned between the work area 30 and the sections n to q. Among the sections a to h, the sections b, d, g, and h are set to be standby sections. The sections a, c, and e are set to be temporary stop sections. The section f is set to be a work section. Among the sections i to q, the sections k, m, o, and q are set to be standby sections. The sections i, n, and p are set to be temporary stop sections. The section j is set to be a work section. In FIG. 2, arrows mark the orientations in which the transport device 100 can travel. The standby sections are marked with circles. The temporary stop sections are marked with squares. The work sections are marked with stars.

The transport device 100 is permitted to wait at the standby section. The transport device 100 can stop at the standby section and wait until the next operation. The transport device 100 that transports the rack stops at the work section. The worker transfers articles with the transport device 100 stopped at the work section. The transport device 100 waits at the work section until the reception of the articles by the worker finishes. The first section 31 and the second section 32 are set respectively adjacent to the work section of the first area 10 and the work section of the second area 20.

As a general rule, at the temporary stop section, the transport device 100 is not permitted to remain stopped, but a temporary stop of the transport device 100 is permitted. The transport device 100 can remain stopped at the temporary stop section only in an emergency such as when another transport device 100 is present at the next destination, etc. Accordingly, for example, in the first area 10 or the second area 20, when the transport device 100 is already waiting at the section b or o which is the initial standby section, it is determined that another transport device 100 would not be able to wait if the other transport device 100 is moved into the first area 10 or the second area 20. The other transport device 100 is not moved into the first area 10 or the second area 20. On the other hand, when the initial standby section is empty, it is determined that the other transport device 100 can be moved into the first area 10 or the second area 20. If the section d or q is empty, the transport device 100 that is waiting at the section b or o moves to the section d or q. If the section d or q is not empty, the transport device 100 continues to wait at the section b or o.

In addition to being a standby section, the section d or q is set to be a rotation section. At the rotation section, the rotation of the transport device 100 is permitted to modify the orientation of the rack being transported. For example, for the rack A1 shown in FIG. 4A, articles can be removed and stored from the front side and the backside. For the rack A2 shown in FIG. 4B, articles can be removed and stored from only the front side. The transport device 100 adjusts the orientation of the rack so that the worker can remove and store the articles at the work section.

In the transport device 100 shown in FIGS. 3A and 3B, the holding part 102 is rotatable with respect to the vehicle body 101. The vehicle body 101 modifies the travel direction at the section d or q. The holding part 102 also rotates with respect to the vehicle body 101 to adjust the orientation of the rack. The vehicle body 101 also modifies the travel direction at the section h or m. At this time, the holding part 102 rotates the same angle as the rotation angle of the vehicle body 101 in the opposite direction of the rotation of the vehicle body 101. As a result, a change of the orientation of the rack can be avoided. When it is unnecessary to adjust the orientation of the rack in the first area 10, the transport device 100 may directly move from the section c to the section g without passing through the section d for rotating the rack. Similarly, when it is unnecessary to adjust the orientation of the rack in the second area 20, the transport device 100 may directly move from the section p to the section k without passing through the section q for rotating the rack.

By setting multiple standby sections in the first and second areas 10 and 20, another transport device 100 can wait at the standby section during the picking task by the worker W. When the picking task is completed, the transport device 100 that is stopped at the work section adjacent to the first section 31 or the second section 32 exits the first area 10 or the second area 20. The transport device 100 that is stopped at the standby section can move immediately to the work section. As a result, the efficiency of the handling can be increased.

In the first and second areas 10 and 20 as shown in FIG. 2, it is favorable for the entry lines to be set to be longer than the exit lines, and to include more standby sections than the exit lines. The number of the transport devices 100 that can wait in the first area 10 or the second area 20 increases as the number of standby sections increases. The transport device 100 that is waiting can be moved to the work section sooner. As a result, after the transport device 100 moves from the work section, another transport device 100 can move to the work section immediately. The transport devices 100 can move sequentially to the work section without interruption, and so the work efficiency can be increased.

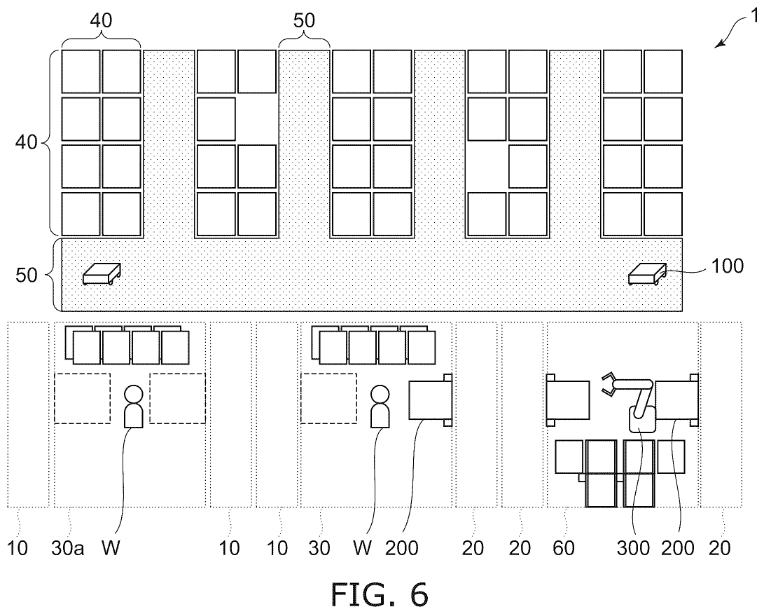

FIG. 6 is a schematic view showing another example of a layout of a warehouse.

As shown in FIG. 6, a work area 30a and a robot work area 60 may be set in addition to the first area 10, the second area 20, the work area 30, the storage area 40, and the travel area 50.

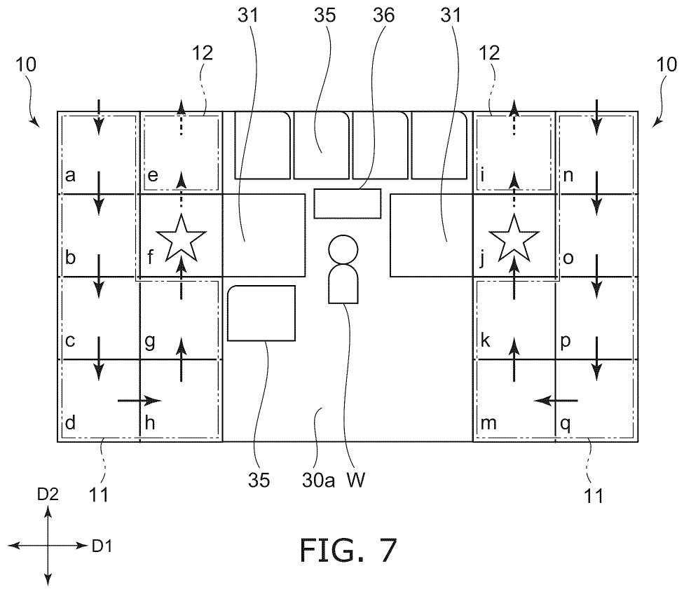

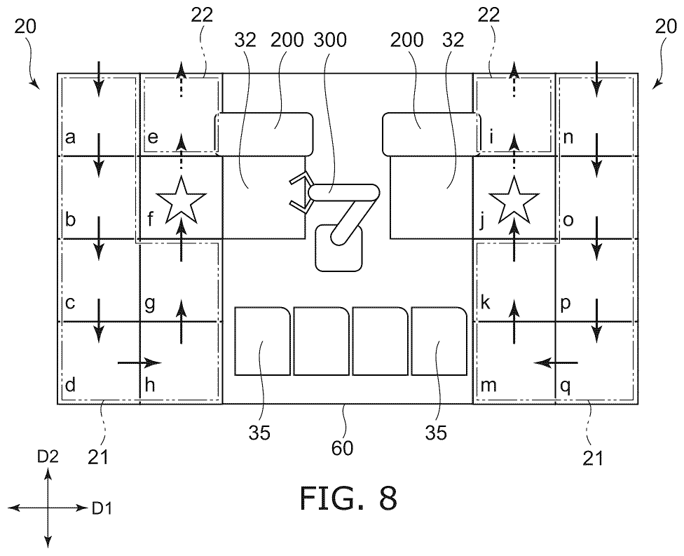

FIG. 7 is a schematic view showing the layout of the work area periphery. FIG. 8 is a schematic view showing the layout of the robot work area periphery.

As shown in FIGS. 6 and 7, the first areas 10 are set respectively at two sides of the work area 30a. In the work area 30a, the first sections 31 are set adjacent respectively to the first areas 10. The take-out device 200 is not installed in the work area 30a. Therefore, in the work area 30a, only articles stored at positions within reach of the worker are handled.

As shown in FIGS. 6 and 8, a picking robot 300 is installed in the robot work area 60. The picking robot 300 performs a picking task similarly to that of the worker. The second areas 20 are set respectively at two sides of the robot work area 60. Two take-out devices 200 are installed in the robot work area 60. The take-out devices 200 receive the articles from the transport devices 100 regardless of the heights at which the articles are stored, and move the articles to heights at which the picking robot 300 can hold the articles. The picking robot 300 transfers the articles removed by the take-out devices 200 to the shipping boxes 35.

In the example shown in FIG. 6, the position in the second direction D2 of the first section 31 and the position in the second direction D2 of the second section 32 are the same in each of the work area 30, the work area 30a, and the robot work area 60. By setting the sections to be at the same position in the second direction D2 in each area, the control of the transport device 100 is easy.

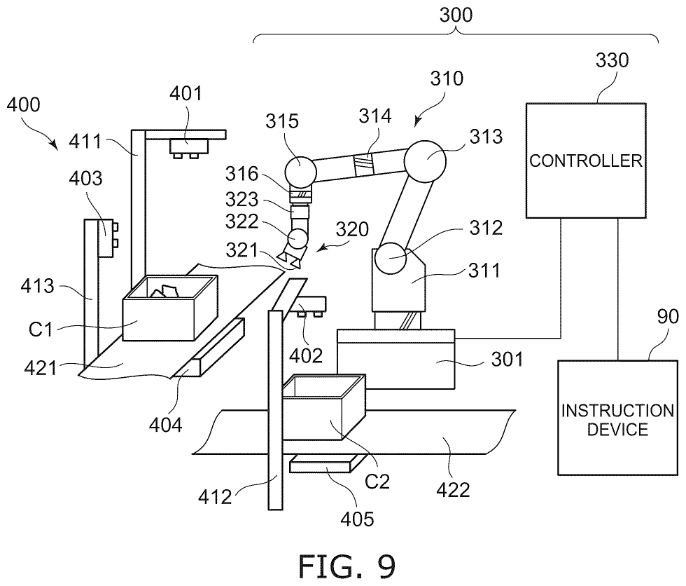

FIG. 9 is a perspective view showing a specific example of a picking robot.

The picking robot 300 shown in FIG. 9 includes a manipulator 310 and an end effector 320. The manipulator 310 is an articulated robot driven by multiple servo motors. In the example shown in FIG. 9, the manipulator 310 is a vertical articulated robot with six axes, i.e., first to sixth axes 311 to 316. The manipulator 310 may include a combination of at least two selected from a vertical articulated robot, a horizontal articulated robot, a linear robot, and a parallel link robot. The end effector 320 is mounted to the distal end of the manipulator 310.

The end effector 320 includes a suction pad 321, a bending axis 322, and a force sensor 323. The suction pad 321 is located at the distal end of the end effector 320 and grasps the article. The suction pad 321 is rotatable with respect to the distal end of the manipulator 310 by the bending axis 322 of the suction pad 321. The force sensor 323 detects the contact of the end effector 320 with the article. Other than suction, the end effector 320 may grasp the article by a technique such as jamming, clamping, grasping with a multi-finger mechanism, etc. The end effector 320 may be equipped with multiple techniques. More diverse articles can be handled thereby.

The picking robot 300 is mounted on a housing 301. In the illustrated example, the end effector 320 holds the article by grasping the upper surface of the article. The picking robot 300 further includes a controller 330. The controller 330 receives instructions from the instruction device 90. The controller 330 performs the picking by controlling the picking robot 300 according to the instruction transmitted from the instruction device 90. As a result, the picking is automatically performed by the picking robot 300.

Other than the picking robot 300, the system for picking includes sensors, a first loading platform, a second loading platform, various sensors, power supplies, cylinders, compressors, vacuum pumps, external interfaces such as UI and the like, safety mechanisms, etc. A first container that stores the article to be picked is loaded onto the first loading platform. A second container into which the removed article is to be stored is loaded onto the second loading platform. The second container is, for example, a shipping box. The power supply supplies power to the various drive parts of the picking robot 300, etc. The cylinders store compressed air. The safety mechanisms include, for example, light curtains, collision detectors, etc.

For example, a sensor system 400 shown in FIG. 9 is included. The sensor system 400 includes a sensor 401, a sensor 402, a sensor 403, a sensor 404, and a sensor 405. The sensor 401 is located above a first loading platform 421 and measures the state inside a first container C1. The sensor 402 is located above a second loading platform 422 and measures the state inside a second container C2. The sensor 403 is located at the vicinity of the sensor 401 and measures the object grasped by the manipulator 310. The sensors 401 to 403 are respectively supported by supporters 411 to 413. The sensors 401 to 403 include sensors that can acquire image information or three-dimensional information, such as RGB image cameras, range image cameras, LRFs, LIDAR, etc. The sensor 404 measures the weight of the first container C1 loaded on the first loading platform 421. The sensor 405 measures the weight of the second container C2 loaded on the second loading platform 422.

As shown in FIG. 9, dedicated platforms may be used as the first loading platform 421 and the second loading platform 422. Mobile mechanisms such as conveyors may be used as the first loading platform 421 and the second loading platform 422. The loading platform 227 of the take-out device 200 shown in FIGS. 5A and 5B may be utilized as the first loading platform 421. Also, the sensor 228 or 229 of the take-out device 200 shown in FIG. 5 may be utilized as an image sensor or a measurement sensor that is a part of the sensor system 400.

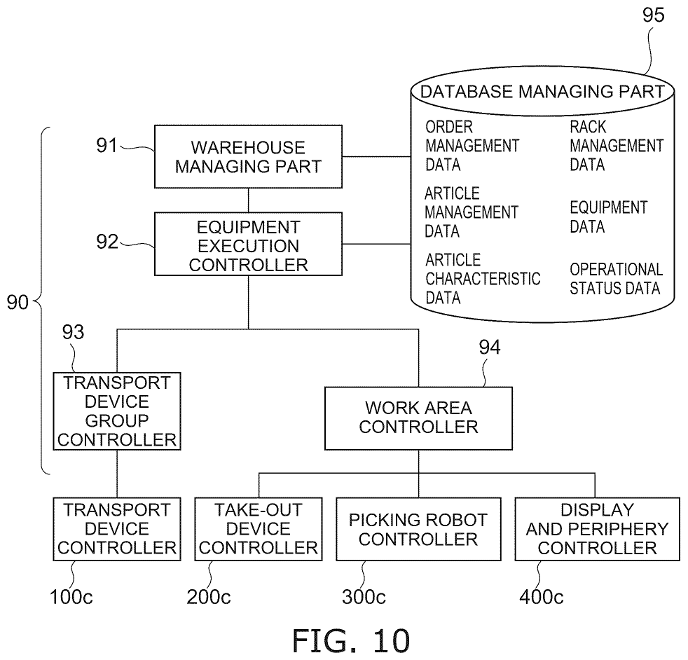

FIG. 10 is a schematic view showing controls according to the handling system according to the embodiment.

The management and control systems of the handling system 1 include the instruction device 90 and the controllers of the devices. The instruction device 90 may be software installed in one calculator (computer), or may be configured using multiple devices such as a server, client computer, etc. The instruction device 90 includes a warehouse managing part 91, an equipment execution controller 92, a transport device group controller 93, a work area controller 94, and a database managing part 95.

The warehouse managing part 91 integrates and manages the inventory status of the articles of the warehouse, order processing, etc. The equipment execution controller 92 controls multiple pieces of equipment inside the warehouse so that the pieces of equipment can operate in cooperation. The transport device group controller 93 instructs transport tasks, operations, etc., to a transport device controller 100c of one or multiple transport devices 100. The work area controller 94 instructs the tasks, operations, display content, etc., to devices installed in the work area 30, the work area 30a, and the robot work area 60. The devices are the processing terminal 36, the take-out device 200, the picking robot 300, etc.

The transport device controller 100c controls the transport device 100 shown in FIGS. 3A and 3B, controls information, etc. The information that is controlled is related to the rack to be transported, and the containers and articles included in the rack. A take-out device controller 200c controls the operation of the take-out device 200 shown in FIGS. 5A and 5B. A picking robot controller 300c controls the picking operation of the picking robot 300 shown in FIG. 9 and information related to the picked article. A display and peripheral device controller 400c controls the processing terminal 36 for the worker, and peripheral devices such as conveyors, safety devices, etc. Information is transmitted between the worker and the instruction device 90 via the processing terminal 36. The database managing part 95 manages data such as order management data, article management data, article characteristic data, rack management data, equipment data, operational status data, etc.

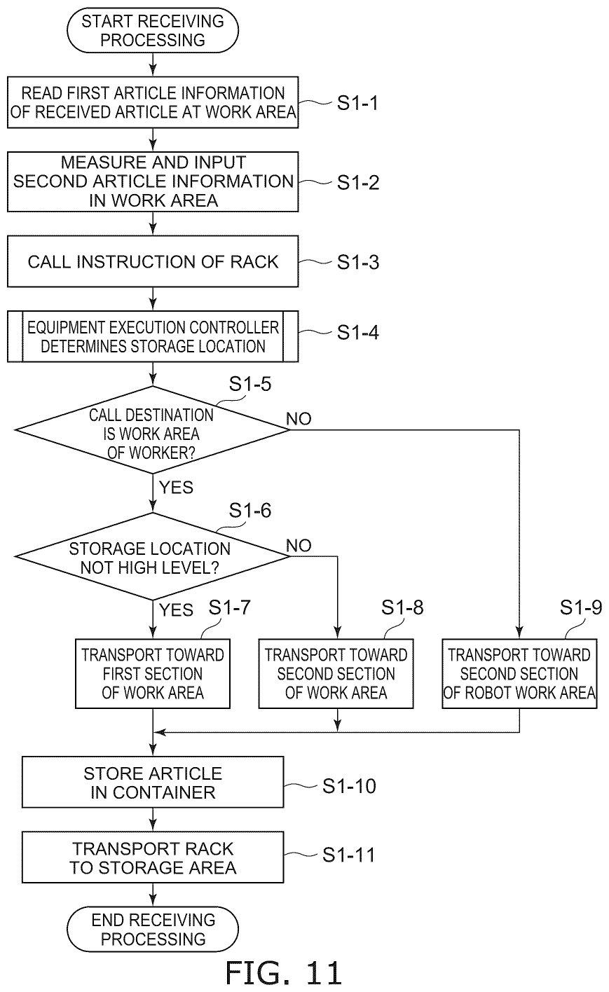

FIG. 11 is a flowchart showing receiving processing according to the handling system according to the embodiment.

FIG. 11 is an example of a processing flow when an article received by the warehouse is stored in a container of the storage area 40. The receiving task is performed in one work area among the work area 30, the work area 30a, or the robot work area. In step S1-1, the received article is brought into the work area. The worker or the picking robot 300 reads article management data as first article information. The article management data that is read includes the barcode of the outer box, the product number, the product name, the manufacturer, the shipper, etc. Also, when article management data is not written on the outer box, the outer box is opened, and article management data written on the stored article is read. The reading includes the input to the processing terminal 36 by the worker, the utilization of a handy terminal such as a barcode reader or the like, barcode reading by a sensor of the picking robot 300, optical character recognition (OCR) of written characters, etc. The information that is read is stored in a database via the warehouse managing part 91, the equipment execution controller 92, the work area controller 94, and the database managing part 95.

Second article information of which the input is not completed in step S1-1 is measured or input in step S1-2. The second article information includes a portion of the article management data, article characteristic data, etc. The article characteristic data includes information related to the exterior form size, weight, and the surface material such as the presence or absence of gloss or the like of the article, information such as the hardness or softness and whether or not deformation of the article occurs, and classification information of the packaging category. The packaging category includes, for example, box, container, pouch, blister, or bag and indicates what the article is packaged in. The article characteristic data may further include information related to handling such as handling precautions, processing disabled or processing enabled for the picking robot 300, etc. The article characteristic data is stored in a database. The article management data that is read in step S1-1 is compared with the data stored in the database, and when corresponding article characteristic data already is in the database, such article characteristic data is utilized. When there is no article characteristic data in the database and when the article characteristic data is insufficient, measurements, etc., are made and registered in the database. The measurements may be performed by the worker, or an image sensor, a weight meter, and a dedicated measurement device can be used. For example, the dedicated measurement device includes a suction mechanism or a clamping support mechanism, and measures characteristics of the article that is held. The picking robot 300 may measure the characteristics by performing a grasping operation or image recognition processing. Information such as the availability of the processing by the picking robot 300, etc., can be automatically determined by determination software installed in the equipment execution controller 92 based on the weight, classification information, etc., that are input.

In step S1-3, a call instruction of the rack to the first area 10 or the second area 20 is transmitted from the instruction device 90 to the transport device 100. The call instruction is automatically transmitted when the work area controller 94 determines that step S1-2 has been completed by the processing terminal 36 of the work area 30, or the work area controller 94 determines that the picking robot 300 and the peripheral devices have completed the task. Also, the worker may use the processing terminal 36 to transmit a call instruction to the transport device 100. In such a case, the worker may designate the size, number, etc., of the necessary container.

In step S1-4, the equipment execution controller 92 determines the appropriate storage location based on the information input in step S1-1 to S1-3. The rack, type of container, number of containers, position at which the rack is installed, position of the container, etc., are determined as the storage location.

In step S1-5, the transport destination of the rack or the container is determined according to the storage location determined by the equipment execution controller 92. The step transitions to step S1-6 when the call destination is the first area 10 or the second area 20 adjacent to the work area 30 or 30a. When the call destination is the second area 20 adjacent to the robot work area 60, the step transitions to step S1-9.

In step S1-6, the transport destination of the rack is determined according to the storage location determined by the equipment execution controller 92. When the storage location is not a container of a high level, the step transitions to step S1-7. When the storage location is a container of a high level, the step transitions to step S1-8. For example, a height beyond the reach of a person when referenced to the average body height or a height that is greater than the body height of a person is set as a “high level”.

In step S1-7, the equipment execution controller 92 issues an instruction to transport the rack determined by step S1-4 to the work area 30 called by the transport device group controller 93. Then, the transport device group controller 93 selects an appropriate transport device 100 from among the multiple transport devices 100 and issues a transport instruction of the rack. The method for selecting the transport device 100 to which the transport instruction is transmitted is arbitrary. For example, a transport device 100 that is operable and is proximate to the corresponding rack is selected. The transport device 100 that receives the transport instruction moves to the corresponding rack placed in the storage area 40 and lifts the rack or removes the container or article inside the rack. Then, the transport device 100 travels through the travel area 50, enters the first area 10 adjacent to the designated work area 30, and transports the rack toward the first section 31.

In step S1-8, the transport device 100 lifts the designated rack or removes the container inside the rack according to the instruction from the equipment execution controller 92. The transport device 100 enters the second area 20 adjacent to the designated work area 30. The transport device 100 transports the rack toward the second section 32 at which the take-out device 200 is installed.

In step S1-9, the transport device 100 lifts the designated rack or removes the container inside the rack according to the instruction from the equipment execution controller 92. The transport device 100 enters the second area 20 adjacent to the designated robot work area 60. The transport device 100 transports the rack toward the second section 32 at which the take-out device 200 is installed.

In step S1-10, the article is stored at the designated position of the rack or container that was transported. The specific content that is performed depends on which of step S1-7 to S1-9 is performed. After step S1-7, the worker stores the article in the container located in the rack at the first section 31 of the work area 30. The worker uses the processing terminal 36 or the handy terminal to register the ID of the container in which the article is stored, the number of articles, etc. The registered information is stored in the database as rack management data, article management data, etc., by the warehouse managing part 91 and the database managing part 95. The worker uses the processing terminal 36 or the handy terminal to complete the task by notifying the warehouse managing part 91 that the task is completed.

After step S1-8, the take-out device 200 removes the designated container from the rack transported by the transport device 100 at the second section 32 of the work area 30. The worker stores the article in the removed container. The worker uses the processing terminal 36 or the handy terminal to register the ID of the container in which the article is stored, the number of articles, etc. The worker uses the processing terminal 36 or the handy terminal to complete task by notifying the warehouse managing part 91 that the task is completed. When receiving the notification, the work area controller 94 transmits an instruction to the take-out device 200. When receiving the instruction, the take-out device 200 returns the container to the original position of the rack. The work area controller 94 confirms that the container is returned, and then completes the task by notifying the result to the equipment execution controller 92.

After step S1-9, the take-out device 200 removes the designated container from the rack transported by the transport device 100 at the second section 32 of the robot work area 60. The picking robot 300 stores the article in the removed container. The sensor system 400 additionally provided to the picking robot 300 detects the ID of the container in which the article is stored, the number of articles, etc., and registers this information. When the completion of the task by the sensor system 400 is detected, the work area controller 94 transmits an instruction to the take-out device 200. When receiving the instruction, the take-out device 200 returns the container to the original position of the rack. The work area controller 94 confirms that the container is returned, and then completes the task by notifying the result to the equipment execution controller 92.

In step S1-11, after confirming the completion of the storage of the article, the equipment execution controller 92 issues a movement instruction to the transport device 100 via the transport device group controller 93. The transport device 100 that receives the movement instruction moves from the work area 30 or the robot work area 60 to the designated position of the storage area 40. As a result, the rack or container in which the received article is stored is transported to the storage area 40. The receiving processing ends when it is confirmed that the transporting is completed, the article is stored at the designated position of the storage area 40, and the rack management data is correctly registered in the database. The rack management data includes the article management data, the article characteristic data, the rack in which the article is stored, the number of articles, etc., for the stored article.

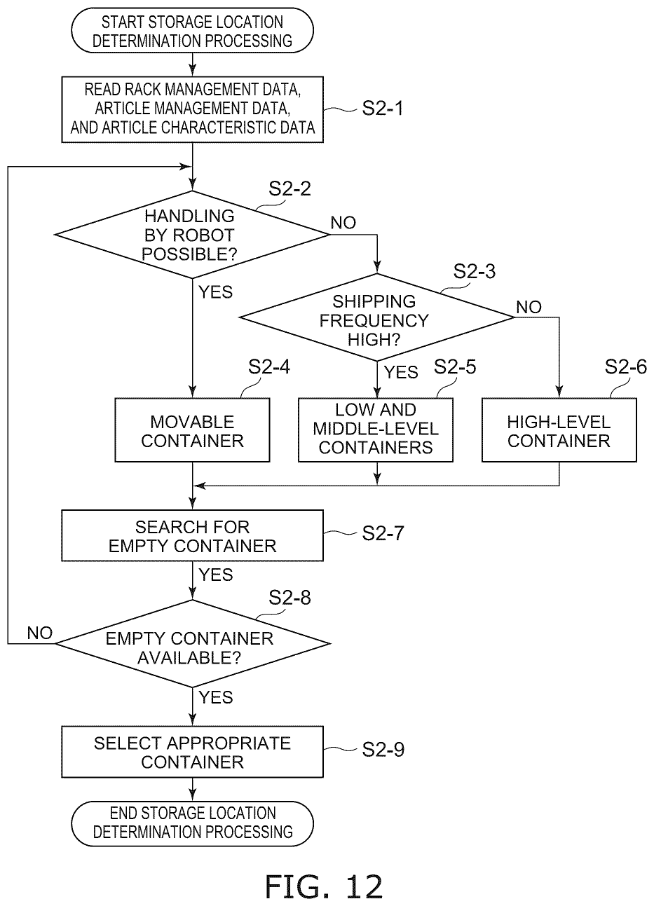

FIG. 12 is a flowchart showing select processing of a storage location according to the handling system according to the embodiment.

The equipment execution controller 92 performs the processing shown in FIG. 12 to select an appropriate storage location of the received article. First, in step S2-1, the equipment execution controller 92 reads data such as the rack management data, the article management data, the article characteristic data, etc., from the database and starts to select an appropriate storage location.

In step S2-2, the equipment execution controller 92 uses the acquired data to determine whether or not the picking robot 300 can handle the target article. Then, the equipment execution controller 92 checks information such as the shipping frequency, whether or not the same product is already stored, etc. When it is determined that the target article can be handled by a picking robot and the shipping frequency or the like is suited to the picking robot 300, the step transitions to step S2-4. When it is determined that the target article is unsuited to handling by the picking robot, the step transitions to step S2-3. The step also transitions to step S2-3 when it is determined that many of the same article already are stored in containers compatible with the picking robot 300 and the article can be handled by the worker. Also, the step transitions to step S2-3 when there are no empty containers compatible with the picking robot 300.

In step S2-3, the equipment execution controller 92 performs a determination using the shipping frequency of the article management data, etc. When the shipping frequency of the target article is determined to be high, the step transitions to step S2-5. When the shipping frequency of the target article is determined not to be high, the step transitions to step S2-6. For example, even when the previous shipping frequency is high, the shipping frequency is determined not to be high if the shipment of the target article may not have a high frequency because many of the same product are already stored and such articles will be shipped in the future. Also, when there is appurtenant information related to empty containers, the step to be transitioned is determined according to the information.

In step S2-4, the equipment execution controller 92 sets the container attribute information for storing the target article to a container compatible with the take-out device 200. Here, when the shipping frequency is relatively high, a flag that designates low and middle-level containers is raised. A low level or a middle level refers to a position lower than a high level. The worker can remove a container of a low level or a middle level from the rack without using the take-out device 200.

In step S2-5, the equipment execution controller 92 sets the container attribute information for storing the target article to low and middle-level containers. In step S2-6, the equipment execution controller 92 sets the container attribute information for storing the target article to a high-level container. In step S2-7, the equipment execution controller 92 searches for empty containers that match the container attribute information and the flag information.

In step S2-8, the equipment execution controller 92 determines whether or not an empty container matches the designated container attribute information and flag information. When there is no empty container, the equipment execution controller 92 provides appurtenant information related to empty containers, and transitions to step S2-2. The appurtenant information indicates that there is no empty container matching the designated attribute information. When there are one or more empty containers, the step transitions to step S2-9.

In step S2-9, when there is one empty container matching the designated container attribute information and flag information, the equipment execution controller 92 selects the container to be the storage location. When there are multiple matching empty containers, an appropriate empty container is selected. In such a case, the rack management data of containers of the same rack are utilized, and shelves having articles with the same attributes and a high likelihood of being shipped simultaneously are preferentially selected.

Also, different shelves are preferentially selected when there are articles with different attributes such as articles at the middle level and the high level with a high likelihood of being shipped simultaneously. That is, if articles that will be shipped simultaneously are stored in levels of different attributes in the same rack, it becomes necessary to sequentially transport the rack to the first and second areas 10 and 20. The articles must be handled in order, and cannot be processed simultaneously. When there are more multiple alternatives for empty containers, the containers for storing are determined by selecting according to the prediction of the shipping frequency so that containers at positions proximate to the work area are selected when the shipping frequency is high, etc.; and the task is completed.

The received article is stored in the storage location/container selected by the processing described above. “Low and middle levels” are examples of the first position. “High level” is an example of the second position. Articles (first articles) having lower shipping frequencies than the articles stored in the containers of the low and middle levels are stored in the containers of the high level. Articles (second articles) having higher shipping frequencies than the articles stored in the containers of the high level are stored in the containers of the low and middle levels.

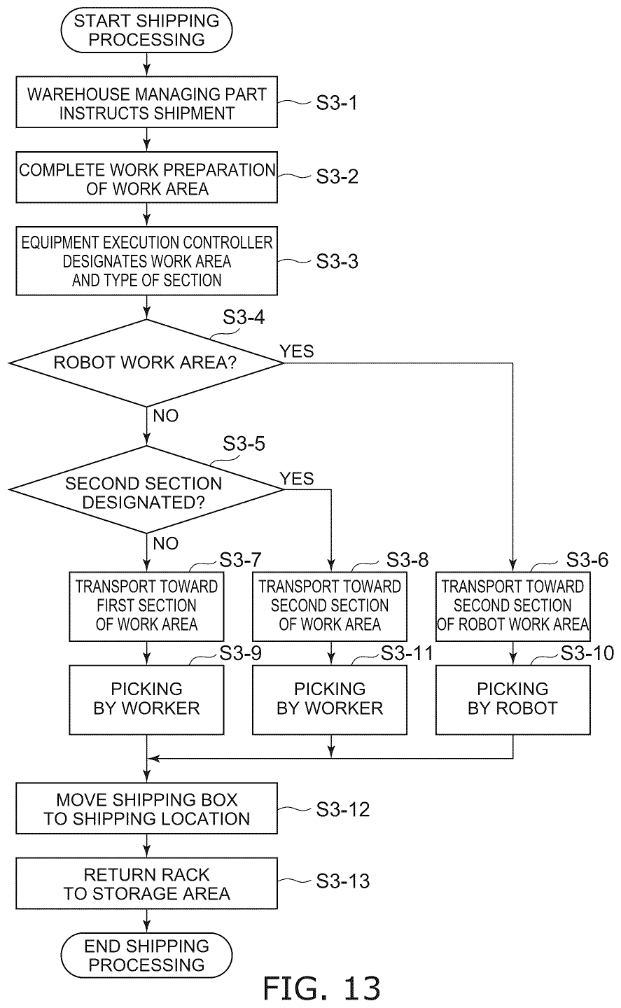

FIG. 13 is a flowchart showing shipping processing according to the handling system according to the embodiment.

In step S3-1, the warehouse managing part 91 generates a shipping list corresponding to an order from a customer or an external system and issues a shipping instruction to the equipment execution controller 92. The shipping list includes multiple tasks. Each task includes information of the shipping destination corresponding to the order, a designation of the articles associated with the shipping destination, and the number of articles.

In step S3-2, preparation of the task is performed in the work area 30 or 30a. At the start time of the task, the worker finishes work preparation such as tidying, etc.; and the preparation of the work area 30 or 30a is completed. The worker notifies the equipment execution controller 92 of the preparation completion of the work area 30 or 30a via the processing terminal 36. In the robot work area 60, when receiving the preparation instruction from the equipment execution controller 92, the work area controller 94 performs preparation processing such as initializing the control of each part, etc. When the processing is completed, the terminal or the picking robot controller 300c installed in the corresponding work area replies with a notification of the preparation completion. The equipment execution controller 92 completes the processing by transitioning the management state of the work area receiving the notification of the preparation completion to the state of the preparation completion.

In step S3-3, based on the shipping list received from the warehouse managing part 91 and the preparation completion status of each work area, the equipment execution controller 92 determines which work areas and which sections are to be used to perform the tasks of the shipping list. For example, when all of the articles included in the task can be processed by the picking robot 300, the equipment execution controller 92 designates the picking task to be performed by the robot work area 60. When all of the articles included in the task are articles stored in the low level, the equipment execution controller 92 designates the processing to be preferentially performed in the work area 30 where the worker is. When an article stored in the high level is included in the task, the equipment execution controller 92 designates the picking task to be performed in the work area 30 in which the take-out device 200 is installed.

In step S3-4, the equipment execution controller 92 starts the operation instruction for the transport device group controller 93 according to the designated content. When the robot work area 60 is designated, the transport device group controller 93 checks whether or not there is a robot work area 60 in a state of being capable of accepting the task. When multiple robot work areas 60 are in a state of being capable of accepting, the transport device group controller 93 preferentially selects the robot work area 60 having fewer transport devices 100 waiting at standby sections. The transport device group controller 93 issues a transport instruction of the rack to the second area 20 adjacent to the selected robot work area 60. In such a case, when the same article as the article to be shipped is stored in multiple containers, the container most proximate to the work area is selected. When the robot work area 60 in which the task is to be performed is determined, the step transitions to step S3-6. When the designated work area is not the robot work area 60, the step transitions to step S3-5. Also, even when the designated work area is the robot work area 60, if none of the robot work areas 60 can accept, the step transitions to step S3-5. “Cannot accept” refers to when all of the robot work areas 60 already are performing tasks, there are no locations at which the transport devices 100 can wait, etc. When it is difficult to perform the task in another type of work area, the determination is re-performed after waiting for a certain period.

In step S3-5, when the designated work area 30 is the work area 30 in which the take-out device 200 is installed, the transport device group controller 93 checks whether or not there is a work area 30 in a state of being capable of accepting the task among the current work areas 30 of the same type. Furthermore, when multiple racks are transported such as when multiple articles are included in the task, etc., the transport device group controller 93 checks the number of racks to be transported and the height (high level or low and middle levels) at which the articles are stored. When multiple work areas 30 are in a state of being capable of accepting, the transport device group controller 93 preferentially selects the work area 30 having fewer transport devices 100 waiting at standby sections or the work area 30 having many available sections. “Available section” refers to the first section 31 or the second section 32 at which a picking task is not being performed. The transport device group controller 93 issues a transport instruction of the rack to the first section 31 or the second section 32 of the selected work area 30. Transport to the first section 31 without the take-out device 200 is determined for the racks from which picking is performed from the low and middle levels. Transport to the second section 32 at which the take-out device 200 is installed is determined for the racks from which picking is performed from the high level. A transport instruction of the rack to the designated section of the selected work area 30 is issued. In such a case, when the same articles as the article of the task are stored in multiple containers, the rack most proximate to the work area 30 is selected. When the transport to the first section 31 is instructed, the step transitions to step S3-7; and when the transport to the second section 32 is instructed, the step transitions to step S3-8.

In step S3-6, the transport device group controller 93 instructs, to the transport device controller 100c, the execution instruction for transporting the designated rack to the designated robot work area 60, and causes the transport device 100 to transport the rack. In such a case, the transport device group controller 93 checks for the transport device 100 that can perform the next operation among the multiple transport devices 100, preferentially selects the transport device 100 predicted to have the shortest movement time, and transmits the instruction to the transport device 100. The transport device 100 that receives the transport instruction transports the designated rack to the robot work area 60 of the designated picking robot 300.

Similarly, in step S3-7, the transport device group controller 93 instructs the transport device 100 to transport. The transport device 100 that receives the transport instruction transports the designated rack toward the designated work area 30.

In step S3-8, the transport device group controller 93 similarly instructs the transport device 100 to transport. The transport device 100 that receives the transport instruction transports the designated rack toward the work area 30 in which the take-out device 200 is installed.

In step S3-9, the worker performs a picking task of the designated article from the arriving rack. Based on the display of the processing terminal 36, the worker checks the article, the position of the container in which the article is stored, and the shipment quantity, and transfers the necessary number of articles from the container to the shipping box 35. The worker confirms the type, number, container, and shipping box of the article with a barcode reader of a handy terminal, etc. The worker completes the task to notifying the work area controller 94 of the task completion.

In step S3-10, the picking robot 300 performs the picking task. When the transport of the rack by the transport device 100 is completed, the take-out device 200 removes the designated container and moves the container to a height at which the picking task is possible according to the instruction of the work area controller 94. When receiving the movement completion instruction of the container, the picking robot 300 images the container and recognizes the state of the articles. The picking robot 300 autonomously calculates the motion plan of the manipulator. The picking robot 300 uses the manipulator to grasp the article, and stores the article in the designated shipping box 35. When the designated number of articles has been stored, the picking robot 300 completes the task by notifying the work area controller 94 of the completion of the processing.

In step S3-11, the worker performs the picking task of the designated articles from the rack arriving at the work area 30. Based on the display of the processing terminal 36, the worker checks the article, the position of the container in which the article is stored, and the shipment quantity. When the rack is transported to the second section 32 having the take-out device 200, the worker waits for the operation of the take-out device 200. When the transport device 100 is confirmed to have stopped at the work section corresponding to the designated second section 32, the work area controller 94 issues an instruction to the take-out device 200 to remove the designated container. The take-out device 200 removes the designated container and moves the container to a height at which the picking task is possible. The worker confirms that the container has moved to the prescribed height by the display of the processing terminal 36, a warning sound, etc., and then picks the necessary articles from the container and stores the articles in the shipping box. The worker confirms the type, number, container, and shipping box of the article with a barcode reader of a handy terminal, etc. The worker controls the take-out device 200 to return the container to the rack, and completes the task by notifying the work area controller 94 of the task completion. The work area controller 94 confirms the task completion notification of the worker and confirms that the take-out device 200 has returned the container to the rack, and transitions to the state of picking task completion.

In step S3-12, the shipping box in which all of the designated articles are stored is moved to a shipping location as necessary. In step S3-13, after confirming the completion of the picking task, the transport device 100 returns the rack by transporting the rack to the storage area 40.

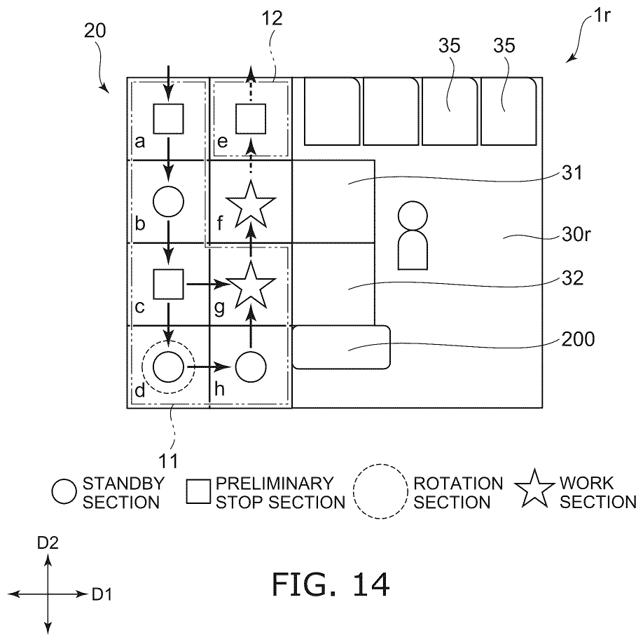

FIG. 14 is a schematic view showing a layout of a work area periphery of a handling system according to a reference example.

In the handling system 1r according to FIG. 14, one second area 20 and one work area 30r are adjacent to each other. In the work area 30r, the first section 31 and the second section 32 are located adjacent to the second area 20.

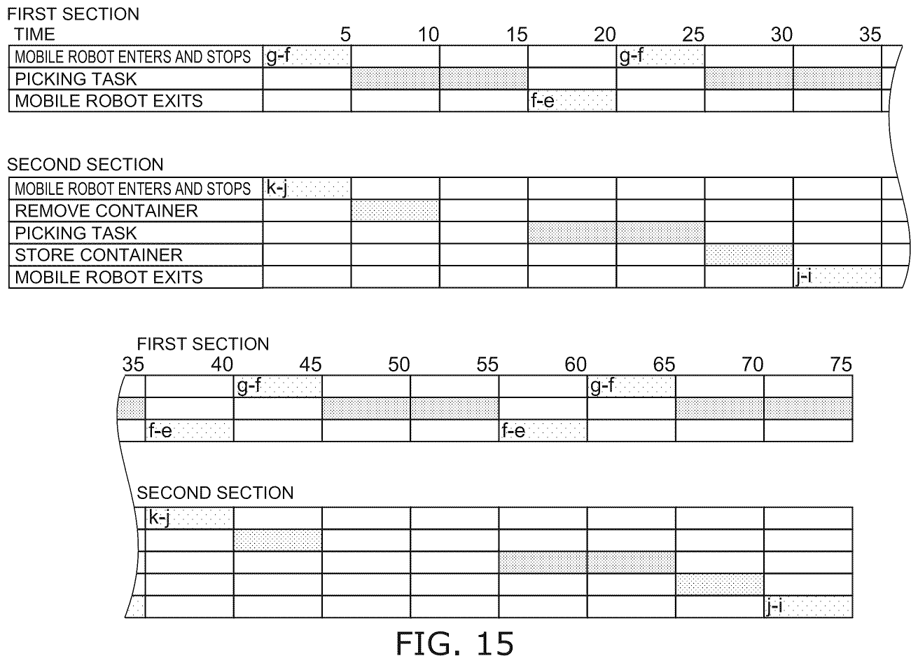

FIG. 15 is a timing chart related to the handling system according to the embodiment.

FIG. 15 shows a timing chart when the picking task is performed in the layout shown in FIG. 2. First, the transport device 100 enters the section f, which is a work section, from the section g, which is a standby section. After 5 seconds, the picking task is started at the first section 31. In parallel to this processing, another transport device 100 enters the section j, which is a work section, from the section k, which is a standby section. After 5 seconds, the container is removed from the rack transported by the take-out device 200.

The worker performs the picking task at the first section 31 from 5 seconds to 15 seconds. After the picking task at the first section 31 is completed, the transport device 100 exits from the section f toward the section e. Continuing, the next transport device 100 enters the section f from the section g. The worker performs the picking task at the second section 32 from 15 seconds to 25 seconds while the transport device 100 is moving in the first area 10.

When the picking task at the second section 32 is completed, the take-out device 200 returns the container to the rack. The transport device 100 to which the rack is returned exits from the section j toward the section i. Continuing, the next transport device 100 enters the section j from the section k. After the picking task at the second section 32, the worker performs the picking task at the first section 31 from 25 seconds to 35 seconds.

Thereafter, similar operations are repeated. In the example, four picking tasks are performed at the first section 31 and two picking tasks are performed at the second section 32 within 75 seconds.

Thus, in the handling system 1 according to the embodiment, the first area 10 and the second area 20 are provided to correspond respectively to the first and second sections 31 and 32, and so there are few constraints for the movement timing of the transport device 100. Also, the picking task can be continuously performed by reducing the frequency of the picking task at the second section 32, which takes more time, to be less than the frequency of the picking task at the first section 31. When receiving the article, the frequency of the picking task at the first and second sections 31 and 32 can be adjusted by determining the storage location by utilizing the shipping frequency information.

Also, in the handling system 1 according to the embodiment, there is an ample margin for the movement time of the transport device 100, the time to remove the container, etc. Therefore, an efficiency reduction of the picking task can be suppressed even when the racks are made higher, the movement speed of the transport device 100 decreases, or the time necessary to remove the container increases.

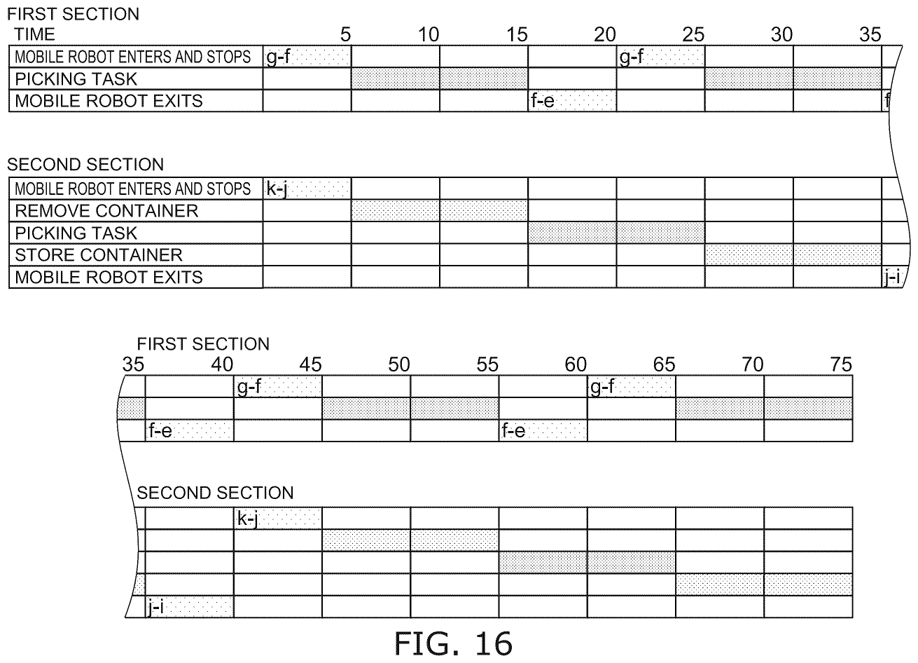

FIG. 16 is another timing chart related to the handling system according to the embodiment.

Compared to the time chart shown in FIG. 15, FIG. 16 shows an example in which the time necessary to remove the container is increased two-fold. It can be seen from the comparison of FIGS. 15 and 16 that even when the time necessary to remove the container increases, the worker can continuously perform the picking task by working at the first section 31 while the container is being removed. In the example shown in FIG. 16, the same number of picking tasks as the example shown in FIG. 15 can be performed within 75 seconds.

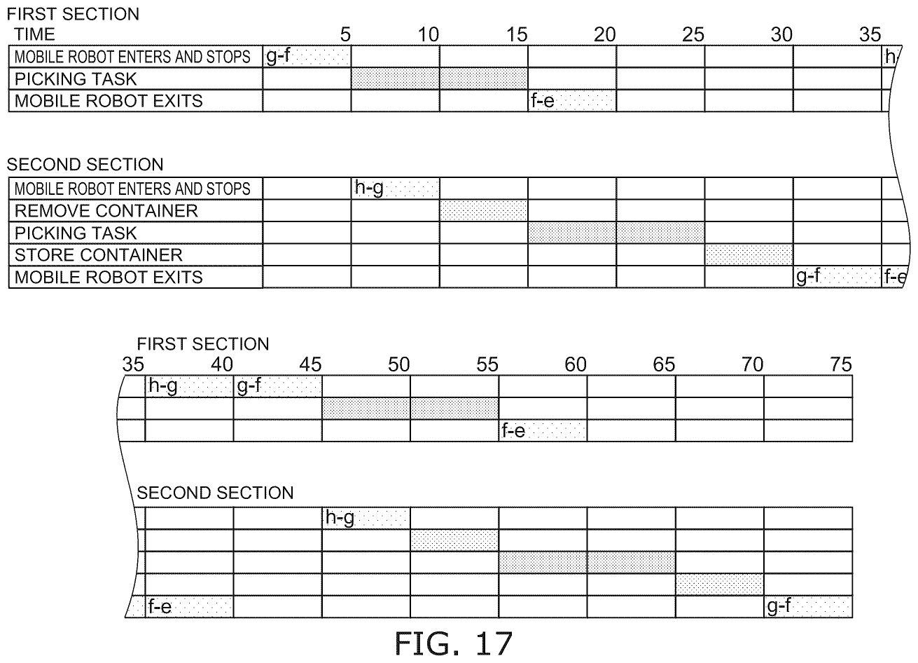

FIG. 17 is a timing chart related to a handling system according to a reference example.

FIG. 17 shows a timing chart when the picking task is performed in the layout shown in FIG. 14. First, the transport device 100 enters the section f from the section g. After 5 seconds, the picking task is started at the first section 31. When the section g becomes empty, the next transport device 100 enters the section g from the section h. After 10 seconds, the removal of the container by the take-out device 200 is started. When the removal of the container is completed, the worker starts the picking task at the second section 32. During the picking task, another transport device 100 cannot move to the section f via the section g. Therefore, the next rack cannot be transported to the section f until 45 seconds have gone by. In the example, two picking tasks are performed at the first section 31 and two picking tasks are performed at the second section 32 within 75 seconds. Thus, when multiple sections for the picking task are set to be adjacent to each other in one area, the efficiency of the picking task is greatly reduced.

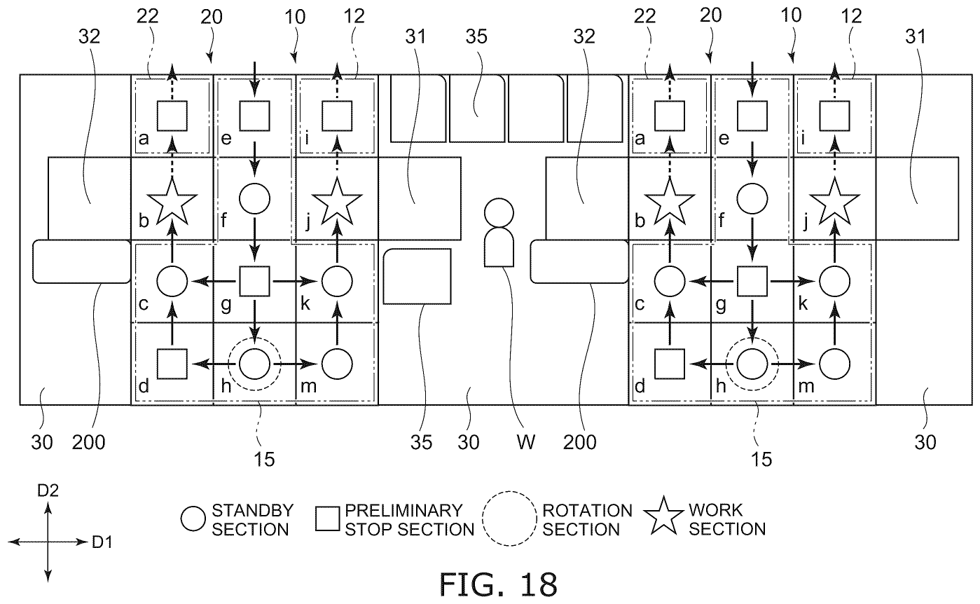

FIG. 18 is a schematic view showing another layout of the work area periphery of the handling system according to the embodiment.

As shown in FIG. 18, when multiple work areas 30 are included, a common entry line 15 may be set for the first and second areas 10 and 20 adjacent to each other. The first area 10 includes the exit line 12 and at least a portion of the entry line 15. The second area 20 includes the exit line 22 and at least a portion of the entry line 15. The entry line 15 is positioned between the first area 10 and the second area 20. The exit line 12 of the first area 10 is positioned between the first area 10 and the entry line 15. The exit line 22 of the second area 20 is positioned between the second area 20 and the entry line 15. The transport device 100 that enters the entry line 15 moves toward the designated first section 31 or second section 32 and toward the exit line 12 or the exit line 22.

Thus, by sharing the entry line between the adjacent work areas 30, the areas of the first and second areas 10 and 20 can be reduced. For example, the area of the storage area 40 can be increased by the amount that the areas of the first and second areas 10 and 20 are reduced, and the storage efficiency as a warehouse can be further increased.

In the example shown in FIG. 18, the entry line for the first section 31 includes the sections e, f, g, h, m, and k; and the exit line 12 for the first section 31 includes the section i. Also, the entry line for the second section 32 includes the sections e, f, g, h, d, and c; and the exit line 22 for the second section 32 includes the section a. The sections e, f, g, and h are common portions of the entry lines of the first and second sections 31 and 32.

Also, the sections k and m of the first area 10 are set to be standby sections. The section c of the second area 20 is set to be a standby section. In other words, the number of standby sections set in the first area 10 is greater than the number of standby sections set in the second area 20.

Also, in the shared entry line 15, the section f is set as a standby section for the transport device 100 moving toward the first section 31, and is set as a temporary stop section for the transport device 100 moving toward the second section 32. The section e and the section g are set as temporary stop sections for all of the transport devices 100. The section h is set as a standby section and a rotation section for all of the transport devices 100.

Thus, in the example shown in FIG. 18, the number of standby sections set in the first area 10 is greater than the number of standby sections set in the second area 20. By setting more standby sections in the first area 10, of which the picking task is performed more quickly, the picking task can be more reliably performed continuously.

The section d is set as a temporary stop section for the transport device 100 moving toward the second section 32. When the transport device 100 rotates the rack at the section h, it is necessary for all three sections of the sections g, d, and m to be empty because the rack juts into the sections at the periphery. If the section d is a temporary stop section, the section d and the section g are empty nearly all of the time. When the transport device 100 waiting at the section m moves to the next section, the transport device 100 at the section h can rotate and then move to the next section m. For example, the racks can be transported to the first section 31 without interruption.

The processing at the second section 32 is slow compared to the processing at the first section 31. When the section d is set as a standby section, there is a possibility that the transport device 100 may dwell at the section d and obstruct the rotation at the section h of the transport device 100 moving toward the first section 31. In other words, when the section d is set to be a standby section, the effects of the second section 32 at which the processing is slow cause the standby time of the transport device 100 toward the first section 31 to lengthen and the efficiency of the processing to decrease. On the other hand, the processing at the first section 31 is relatively fast, and the time of the transport device 100 dwelling at the section m is short. Therefore, by setting the section d to be a temporary stop section and by suppressing the dwell of the transport device 100, continuous processing at the first section 31 is possible. Thus, to increase the processing efficiency, it is effective to set the sections adjacent to the rotation section to be sections having different functions between the first area 10 and the second area 20.

In the example above, the section f is set as a standby section for only the transport device 100 moving toward the first section 31. The section f also may be set as a standby section for the transport device 100 moving toward the second section 32. In any case, the number of standby sections set in the first area 10 is greater than the number of standby sections set in the second area 20. In the layout of FIG. 18, the first section 31 is capable of accepting when at least the section f is empty; and the second section 32 is capable of accepting when at least the section f and the section h are empty.

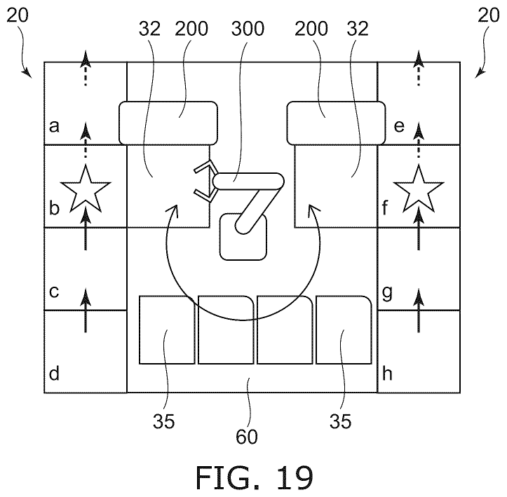

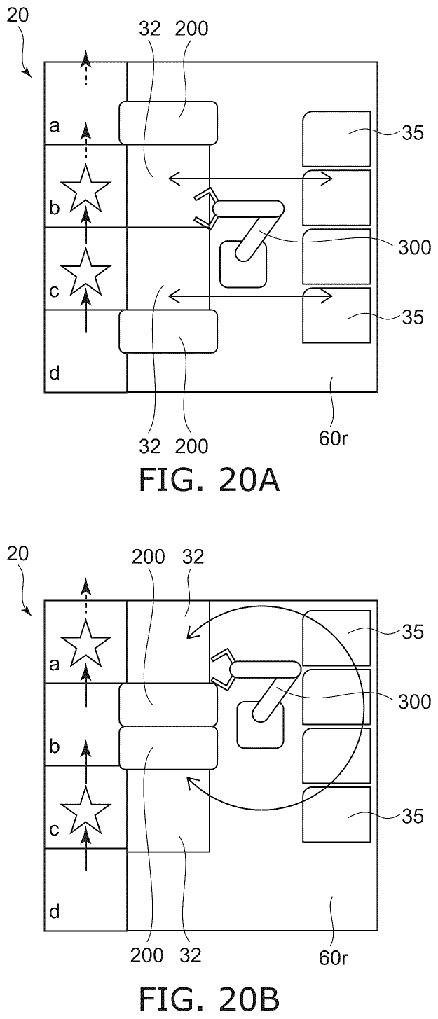

FIG. 19 is a schematic view showing a layout of a robot work area periphery of the handling system according to the embodiment. FIGS. 20A and 20B are schematic views showing layouts of robot work area peripheries of handling systems according to reference examples.

In the layout of FIG. 19, two second areas 20 face each other with the robot work area 60 interposed. The second sections 32 are located adjacent respectively to the second areas 20. In the layouts of FIGS. 20A and 20B, a robot work area 60r and one second area 20 are adjacent to each other. Multiple second sections 32 are set adjacent to the one second area 20. In the layout of FIG. 19, the shipping boxes 35 and the second sections 32 can be proximate by locating the picking robot 300 between the second sections 32. The motion distance of the manipulator of the picking robot 300 when the picking robot 300 stores the articles in the shipping boxes 35 can be reduced. Also, by locating the take-out devices 200 and the shipping boxes 35 at opposite sides of the second section 32, the manipulator can operate in an arc-like shape without interfering with the take-out devices 200. As a result, the operation speed of the picking robot 300 can be increased.

In the layout of FIG. 20A, the take-out devices 200 are obstacles; the manipulator cannot operate in an arc-like trajectory; and the operation speed of the picking robot 300 is slow. In the layout of FIG. 20B, the manipulator can operate in an arc-like shape, but the picking robot 300 is located between the second section 32 and the shipping boxes 35. The distance between the second section 32 and the shipping boxes 35 is increased, and the motion distance of the manipulator is increased. As a result, time necessary for the picking task increases.

Thus, by setting the second sections 32 adjacent to mutually facing second areas 20, the processing speed of the picking robot 300 can be increased. Also, in the handling system 1 as shown in FIG. 1, the positional relationship of the two second areas 20 with respect to the robot work area 60 is the same as the positional relationship the first area 10 and the second area 20 with respect to the work area 30. It is therefore easy to standardize the control by the equipment execution controller 92.

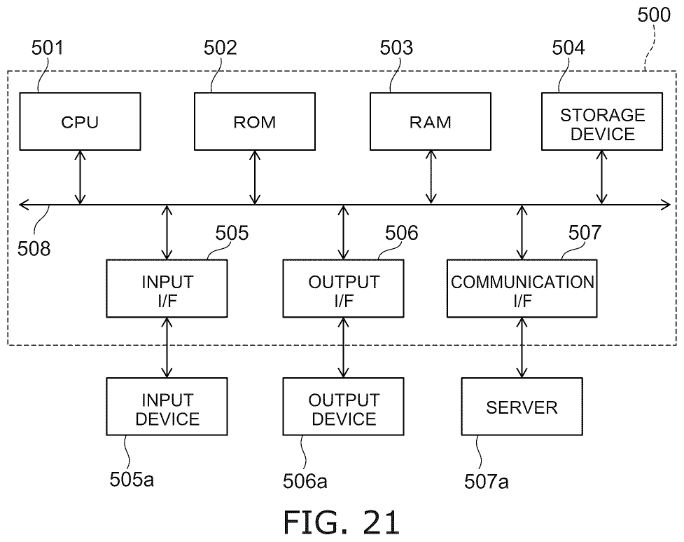

FIG. 21 is a schematic view illustrating a hardware configuration.

For example, the instruction device 90 has the hardware configuration illustrated in FIG. 21. A computer 500 illustrated in FIG. 21 includes a CPU 501, ROM 502, RAM 503, a storage device 504, an input interface 505, an output interface 506, and a communication interface 507.

The ROM 502 stores programs controlling operations of the computer 500. The ROM 502 stores programs necessary for causing the computer 500 to realize the processing described above. The RAM 503 functions as a memory region into which the programs stored in the ROM 502 are loaded.

The CPU 501 includes a processing circuit. The CPU 501 uses the RAM 503 as work memory and executes the programs stored in at least one of the ROM 502 or the storage device 504. When executing the programs, the CPU 501 controls configurations via a system bus 508 and executes various processing.

The storage device 504 stores data necessary for executing the programs and/or data obtained by executing the programs.

The input interface (I/F) 505 connects the computer 500 and an input device 505a. The input I/F 505 is, for example, a serial bus interface such as USB, etc. The CPU 501 can read various data from the input device 505a via the input I/F 505.

The output interface (I/F) 506 connects the computer 500 and an output device 506a. The output I/F 506 is, for example, an image output interface such as Digital Visual Interface (DVI), High-Definition Multimedia Interface (HDMI (registered trademark)), etc. The CPU 501 can transmit data to the output device 506a via the output I/F 506 and cause the output device 506a to output the data.

The communication interface (I/F) 507 connects the computer 500 and a server 507a outside the computer 500. The communication I/F 507 is, for example, a network card such as a LAN card, etc. The CPU 501 can read various data from the server 507a via the communication I/F 507.

The storage device 504 includes at least one selected from a hard disk drive (HDD) and a solid state drive (SSD). The input device 505a includes at least one selected from a mouse, a keyboard, a microphone (audio input), and a touchpad. The output device 506a includes at least one selected from a monitor, a projector, and a printer. A device such as a touch panel that functions as both the input device 505a and the output device 506a may be used.

According to the instruction device, the handling system, or the handling method described above, articles at high positions of the transport device can be transferred to and from the worker while suppressing an efficiency reduction of the handling. Also, similar effects can be obtained by using a program that causes a computer to operate as the instruction device.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium (non-transitory computer-readable storage medium).

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. An instruction device,
in shipping processing, the instruction device:
causing a plurality of transport devices transporting articles to move respectively to a first area and a second area, the first area and the second area facing each other with a work area interposed, a worker being in the work area;
causing one of the plurality of transport devices to transfer the article with the worker in a first section adjacent to the first area; and
causing another one of the plurality of transport devices to transfer the article with the worker via a take-out device in a second section adjacent to the second area, the take-out device removing the article from the other one of the plurality of transport devices.

2. The instruction device according to claim 1, wherein
the article is stored in a rack, and
in receiving processing, the instruction device:
instructs a storage of a first article at a first position of the rack; and
instructs a storage of a second article at a second position of the rack, the second position being higher than the first position, the second article having a lower shipping frequency than the first article.

3. The instruction device according to claim 1, wherein
the article is stored in a container of a rack, and
in receiving processing, the instruction device instructs a storage, in the container that can be removed from the rack, of the article that can be handled by a picking robot.

4. The instruction device according to claim 1, wherein
an entry line and an exit line are set in each of the first and second areas,
the plurality of transport devices that enter move to work sections along the entry lines,
the plurality of transport devices that exit move from the work sections along the exit lines,
the first section is set to be adjacent to the work section of the first area, and
the second section is set to be adjacent to the work section of the second area.

5. The instruction device according to claim 4, wherein
the first area, the work area, and the second area are repeatedly set, and
a common entry line among the entry lines is set at one of a plurality of the first areas and one of a plurality of the second areas that are adjacent to each other.

6. The instruction device according to claim 5, wherein
standby sections, at which one or more of the plurality of transport devices waits, are set respectively in a plurality of the entry lines.

7. The instruction device according to claim 6, wherein
a number of the standby sections set for the one of the plurality of second areas is greater than a number of the standby sections set for the one of the plurality of first areas.

8. The instruction device according to claim 1, wherein
the article is stored in a rack, and
the take-out device is raised or lowered according to a position of the article stored in the rack.

9. A handling system, comprising:
the instruction device according to claim 1;
the plurality of transport devices; and
the take-out device.

10. A handling system, comprising:
a plurality of transport devices transporting articles;
a first area and a second area set so that the plurality of transport devices can move to the first and second areas, the first area and the second area facing each other with a work area interposed, a worker being in the work area;
a first section set adjacent to the first area, the worker transferring the article with a portion of the plurality of transport devices at the first section; and
a second section set adjacent to the second area, the worker using an auxiliary device to transfer the article with another portion of the plurality of transport devices at the second section.

11. The handling system according to claim 10, wherein
the one of the plurality of transport devices and the other one of the plurality of transport devices transport a rack that can store the article, and
the other one of the plurality of transport devices also transports an additional rack added at a higher position than the rack.

12. The handling system according to claim 11, wherein
the additional rack stores a container that can be removed.

13. The handling system according to claim 10, wherein
the auxiliary device is a take-out device removing the article from the other one of the plurality of transport devices.

14. A handling method, comprising:
moving a plurality of transport devices respectively to a first area and a second area, the plurality of transport devices transporting articles, the first area and the second area facing each other with a work area interposed, a worker being in the work area;
causing one of the plurality of transport devices to transfer the article with the worker in a first section adjacent to the first area; and
causing another one of the plurality of transport devices to transfer the article with the worker via a take-out device in a second section adjacent to the second area, the take-out device removing the article from the other one of the plurality of transport devices.

15. A storage medium storing a program,
the program causing a computer to transmit an instruction to:
cause a plurality of transport devices transporting articles to move respectively to a first area and a second area, the first area and the second area facing each other with a work area interposed, a worker being in the work area;
cause one of the plurality of transport devices to transfer the article with the worker in a first section adjacent to the first area; and
cause another one of the plurality of transport devices to transfer the article with the worker via a take-out device in a second section adjacent to the second area, the take-out device removing the article from the other one of the plurality of transport devices.
